(19) United States
(12) Patent Application Publication
(10) Pub. No.: US 2014/0081637 A1
(43) Pub. Date: Mar. 20, 2014

(54) Turn-Taking Patterns for Conversation Identification

(71) Applicant: Google Inc., Mountain View, CA (US)

(72) Inventors: Christopher Richard Wren, Arlington, MA (US); Jak Schibley, Plymouth, MA (US)

(73) Assignee: Google Inc., Mountain View, CA (US)

(21) Appl. No.: 14/026,892

(22) Filed: Sep. 13, 2013

Related U.S. Application Data
(60) Provisional application No. 61/701,017, filed on Sep. 14, 2012.

(51) Int. Cl. G10L 19/018; G10L 17/00

(52) U.S. Cl. CPC G10L 19/018; G10L 17/005
USPC 704/246

(57) ABSTRACT

A method for identifying a conversation between a plurality of participants that includes monitoring voice streams in proximity to client devices and assigning a tag to identify the participants speaking in the voice streams in proximity to the client devices. The method also includes forming a fingerprint, based on the assigned tags, for the voice streams in proximity to the client devices. The method also includes identifying which participants are participating in a conversation based on the fingerprints for the voice streams and providing an interface to the client devices including graphical representations depicting the participants in the conversation.

### CROSS-REFERENCE TO RELATED APPLICATION

This patent application claims the benefit of U.S. Provisional Patent Application No. 61/701,017, filed Sep. 14, 2012, which is incorporated herein by reference.

### BACKGROUND OF THE INVENTION

1. Field of the Invention

The disclosure relates to identifying participants of a conversation based on turn-taking patterns in the conversation.

2. Background.

It is generally difficult for a group of people having a conversation to share information with one another without breaking the flow of conversation and distracting each other. Adequate systems do not exist for accurately identifying the participants of a conversation to enable information to be efficiently shared. A need therefore exists for improved methods and systems for identifying a conversation between a plurality of participants.

### BRIEF SUMMARY OF THE INVENTION

One embodiment is a method for identifying a conversation between a plurality of participants. The method includes monitoring voice streams in proximity to at least one client device. The method includes assigning a tag to identify each participant speaking in the voice streams in proximity to the at least one client device. The method includes forming a fingerprint, based on the assigned tags, for the voice streams in proximity to the at least one client device. The method includes identifying which participants are participating in a conversation based on the fingerprints for the voice streams. The method includes providing an interface to the at least one client device including graphical representations depicting the participants in the conversation.

In some embodiments, the fingerprint includes, for each participant, the assigned tag and a parameter associated with the participant speaking in the voice stream. In some embodiments, the parameter associated with the participant speaking in the voice stream is duration of the participant speaking. In some embodiments, the fingerprint for each voice stream includes fingerprint entries for participant individually speaking for a duration of time, two or more participants simultaneously speaking for a duration of time, or a combination of both. In some embodiments, the at least one client device includes first and second client devices and identifying which participants are participating in a conversation based on the fingerprint for each voice stream includes mapping participants associated with the first client device to participants associated with the second client device.

In some embodiments, the method includes mapping participants associated with the first client device to participants associated with the second client device based on a subset of the fingerprint for each voice stream. In some embodiments, the method includes defining a first conversation group that includes those participants identified as participating in the conversation. In some embodiments, the method includes identifying new participants participating in the conversation group. In some embodiments, the method includes enabling each participant participating in the conversation group to transmit information to the other participants in the conversation group.

In some embodiments, the client devices share a common clock or synchronization signal to align the fingerprints for each client device to map participants associated with the first client device to participants associated with the second client device. In some embodiments, the steps of monitoring, assigning, and forming are performed by each client device.

In some embodiments, the assigning or forming are performed by a common processor. In some embodiments, the interface includes graphical representations of icons that enable a participant to execute code representing instructions that allow a participant to share information with another participant.

Another embodiment is a system for identifying a conversation between a plurality of participants. The system includes a voice monitoring module configured to monitor voice streams in proximity to first and second client devices. The system includes a tagging module configured to assign a tag to identify the participants speaking in the voice streams in proximity to the first and second client devices. The system includes a fingerprinting module to form a fingerprint, based on the assigned tags, for the voice streams in proximity to the first and second client devices. The system includes a conversation identification module configured to identify which participants are participating in a conversation based on the fingerprints for the voice streams.

In some embodiments, the fingerprint includes, for each participant, the assigned tag and a parameter associated with the participant speaking in the voice stream. In some embodiments, the parameter associated with the participant speaking in the voice stream is a duration of time of the participant speaking. In some embodiments, the fingerprint for each voice stream includes fingerprint entries for the participant speaking for the duration of time, two or more participants simultaneously speaking for the duration of time, or a combination of both.

In some embodiments, the conversation identification module is configured to map participants associated with the first client device to participants associated with the second client device. In some embodiments, the conversation identification module is configured to map participants associated with the second client device based on a subset of the fingerprint for each voice stream. In some embodiments, the system is configured to enable each participant participating in the conversation to transmit information to each other via the first and second client devices.

In some embodiments, the system has a common clock or synchronization signal to align the fingerprints for each client device to map participants associated with the first client device to participants associated with the second client device. In some embodiments, each client device includes a voice monitoring module, a tagging module and a fingerprinting module.

Another embodiment is a computer program product, tangibly embodied in an information carrier. The computer program product includes instructions being operable to cause a data processing apparatus to monitor voice streams in proximity to participants each having a client device. The computer program product also includes instructions being operable to cause the data processing apparatus to assign a tag to identify each participant speaking in each voice stream in proximity to each client device. The computer program product also includes instructions being operable to cause the data processing apparatus to form a fingerprint, based on the assigned tags, for each voice stream in proximity to each client device. The computer program product also includes instructions being operable to cause the data processing apparatus to identify which participants are participating in a conversation based on the fingerprints for each voice stream.

Another embodiment is a system for identifying a conversation between a plurality of participants. The system includes a processor and a memory. The memory includes code representing instructions that when executed cause the processor to monitor voice streams in proximity to first and second client devices. The memory includes code representing instructions that when executed cause the processor to assign a tag to identify the participants speaking in the voice streams in proximity to the first and second client devices. The memory includes code representing instructions that when executed cause the processor to form a fingerprint, based on the assigned tags, for the voice streams in proximity to the first and second client devices. The memory includes code representing instructions that when executed cause the processor to identify which participants are participating in a conversation based on the fingerprints for the voice streams.

The conversation participant methods and systems described herein (hereinafter “technology”) can provide one or more of the following advantages. One advantage of the technology is its ability to identify one or more conversations being conducted in a group of people. Another advantage is the ability to identify the participants of a conversation. Another advantage of the technology is to permit participants in a conversation to easily share information with other participants in the same conversation. Another advantage is participants are able to identify other participants in a manner that does not require the participants to become distracted when using a mobile device to share information.

Other aspects and advantages of the technology will become apparent from the following detailed description, taken in conjunction with the accompanying drawings, illustrating the principles of the technology by way of example only.

### BRIEF DESCRIPTION OF THE SEVERAL VIEWS OF THE DRAWING(S)

The foregoing features of various embodiments will be more readily understood by reference to the following detailed descriptions in the accompanying drawings.

FIG. 1 is a schematic illustration of a system identifying a conversation between a plurality of participants, according to an illustrative embodiment.

FIG. 2 is a block diagram illustrating components of a client device, according to an illustrative embodiment.

FIG. 3 is a flowchart of a method for identifying a conversation between a plurality of participants, according to an illustrative embodiment.

FIG. 4 is a flowchart of a method for identifying a conversation between a plurality of participants, according to an illustrative embodiment.

### DETAILED DESCRIPTION OF THE INVENTION

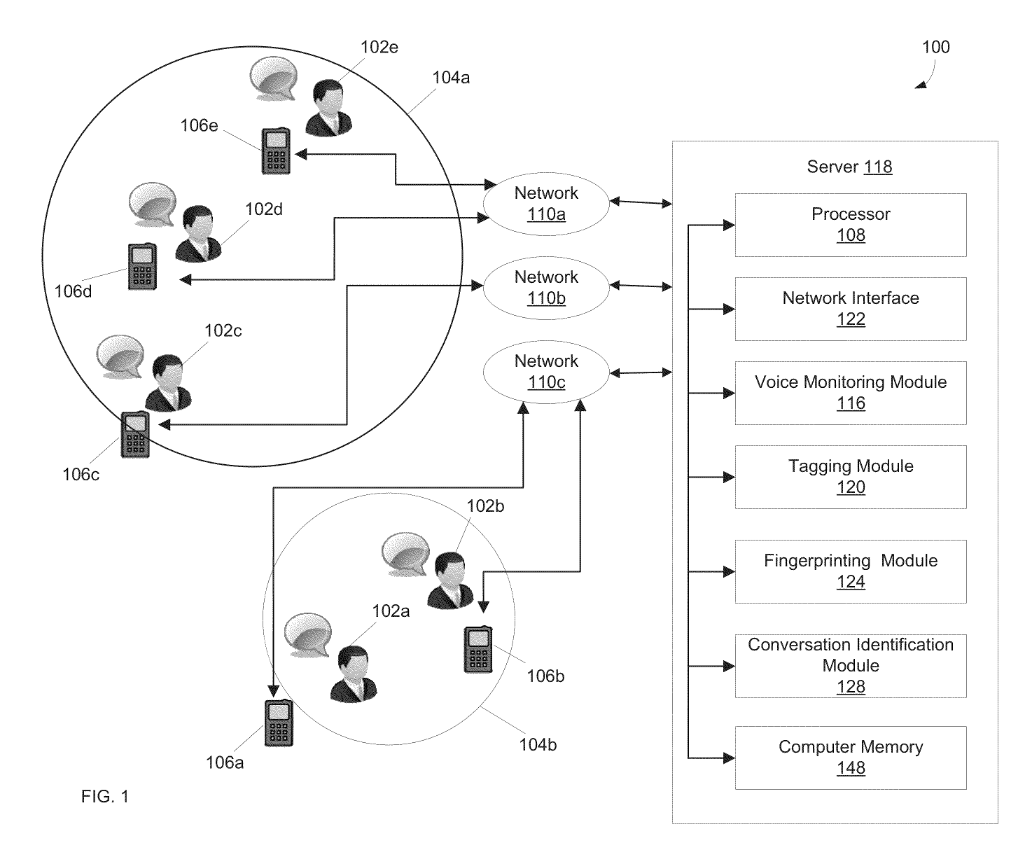

FIG. 1 is a schematic illustration of a system 100 for identifying a conversation between a plurality of participants 102a, 102b, 102c, 102d, and 102e (generally 102), according to an illustrative embodiment. The system 100 includes a plurality of client devices 106a, 106b, 106c, 106d, and 106e (generally 106). In certain embodiments, the client device 106 may be a mobile device or a telecommunication device. Each client device 106 monitors voice streams in proximity to the client device 106 and transmits the voice streams to a network interface 122 of server 118, via, for example, one or more data networks 110a, 110b and 110c (generally 110). The network interface 112 relays the voice streams to a processor 108. In the illustrated embodiment of FIG. 1, a single processor 108 is shown. However, in other embodiments, more than one processor 108 may be implemented.

In this embodiment, participants 102a and 102b are participating in conversation 104b and participants 102c, 102d, and 102e are participating in conversation 104a. The voice streams monitored by client devices 106a and 106b are transmitted to network 110c and then to the processor 108. The voice streams monitored by client devices 106d and 106e are transmitted to network 110a and then to the processor 108. The voice streams monitored by client device 106c are transmitted to network 110b and then to the processor 108.

The networks 110 in FIG. 1 are generally wireless networks. Example networks include but are not limited to Wide Area Networks (WAN) such as a Long Term Evolution (LTE) network, a Global System for Mobile Communications (GSM) network, a Code Division Multiple Access (CDMA) network, Wireless Local Area Networks (WLAN) such as the various IEEE 802.11 standards, or any other kind of data network. The data networks 110 allow the client devices 106 to communicate with the server 118. For example, client devices 106 may transmit information to the server 118 and receive information from the server 118. Data networks 110 may include a set of cell towers, as well as a set of base stations and/or mobile switching centers (MSCs). In some embodiments, the data networks 110 may include various cell tower/base station/MSC arrangements.

The system 100 also includes one or more of a plurality of modules that process the voice streams and data signals generated by the system 100. The system 100 includes a voice monitoring module 116, tagging module 120, fingerprinting module 124, conversation identification module 128, and computer memory 148. The voice monitoring module 116 is configured to monitor voice streams generated by the participants 102 in proximity to the client devices 106. The tagging module 120 is configured to assign a tag to identify the participants 102 speaking in the voice streams.

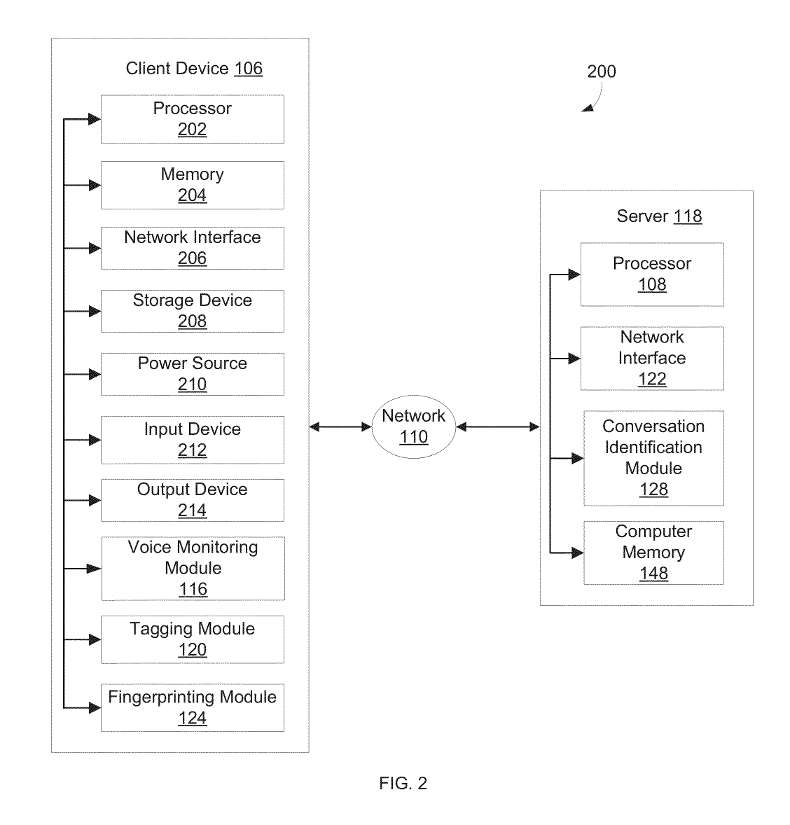

The fingerprinting module 124 forms a fingerprint for the voice streams. The fingerprint is formed based on the assigned tags. The conversation identification module 128 is configured to identify which participants 102 are participating in a conversation based on the fingerprints for the voice streams. In this embodiment, voice monitoring module 116, tagging module 120, and fingerprinting module 124 are coupled to the processor 108 to process all the voice streams. However, in other embodiments, the client devices 106 may include some of the components of the server 118. One such embodiment is illustrated in FIG. 2.

FIG. 2 illustrates an exemplary client device 106, which includes a processor 202, memory 204, network interface 206, storage device 208, power source 210, input device(s) 212, output device(s) 214, voice monitoring module 116, tagging module 120, and fingerprinting module 124. Each of the components including the processor 202, memory 204, network interface 206, storage device 208, power source 210, input device(s) 212, output device(s) 214, voice monitoring module 116, tagging module 120, and fingerprinting module 124 are interconnected physically, communicatively, and/or operatively for intercomponent communications.

As illustrated, processor 202 is configured to implement functionality and/or process instructions for execution within client device 106. For example, processor 202 executes instructions stored in memory 204 or instructions stored on a storage device 208. Memory 204, which may be a non-transient, computer-readable storage medium, is configured to store information within client device 106 during operation. In some embodiments, memory 204 includes a temporary memory, an area for information not to be maintained when the client device 106 is turned off. Examples of such temporary memory include volatile memories such as random access memories (RAM), dynamic random access memories (DRAM), and static random access memories (SRAM). Memory 204 also maintains program instructions for execution by the processor 202.

Storage device 208 also includes one or more non-transient computer-readable storage media. The storage device 208 is generally configured to store larger amounts of information than memory 204. The storage device 208 may further be configured for long-term storage of information. In some examples, the storage device 208 includes non-volatile storage elements. Non-limiting examples of non-volatile storage elements include magnetic hard discs, optical discs, floppy discs, flash memories, or forms of electrically programmable memories (EPROM) or electrically erasable and programmable (EEPROM) memories.

The client device 106 uses network interface 206 to communicate with external devices via one or more networks, such as the data networks 110 of FIG. 1, one or more wireless networks, and other types of networks through which a communication with the client device 106 may be established. Network interface 206 may be a network interface card, such as an Ethernet card, an optical transceiver, a radio frequency transceiver, or any other type of device that can send and receive information. Other non-limiting examples of network interfaces include Bluetooth®, 3G and WiFi® radios in client computing devices, and USB.

The client device 106 includes one or more input devices 212. Input devices 212 are configured to receive input from a user or a surrounding environment of the user through tactile, audio, and/or video feedback. Non-limiting examples of input device 212 include a presence-sensitive screen, a mouse, a keyboard, a voice responsive system, video camera, microphone or any other type of input device. In some examples, a presence-sensitive screen includes a touch-sensitive screen.

One or more output devices 214 are also included in client device 106. Output devices 214 are configured to provide output to a user using tactile, audio, and/or video stimuli. Output device 214 may include a display screen (part of the presence-sensitive screen), a sound card, a video graphics adapter card, or any other type of device for converting a signal into an appropriate form understandable to humans or machines. Additional examples of output device 214 include a speaker such as headphones, a cathode ray tube (CRT) monitor, a liquid crystal display (LCD), or any other type of device that can generate intelligible output to a user.

The client device 106 includes one or more power sources 210 to provide power to the device. Non-limiting examples of power source 210 include single-use power sources, rechargeable power sources, and/or power sources developed from nickel-cadmium, lithium-ion, or other suitable material.

In the embodiment illustrated in FIG. 2, the client device 106 includes the voice monitoring module 116, tagging module 120, and fingerprinting module 124. Similar to the embodiment illustrated in FIG. 1, the voice monitoring module 116 is configured to monitor voice streams generated by the participants 102 in proximity to the client device 106, the tagging module 120 is configured to assign a tag to identify the participants 102 speaking in the voice streams, and the fingerprinting module 124 forms a fingerprint for the voice streams based on the assigned tags. The client device 106 then transmits, over network 110, the fingerprints to the conversation identification module 128 at the server 118, which is configured to identify the participants 102 of a conversation based on the fingerprints for the voice streams.

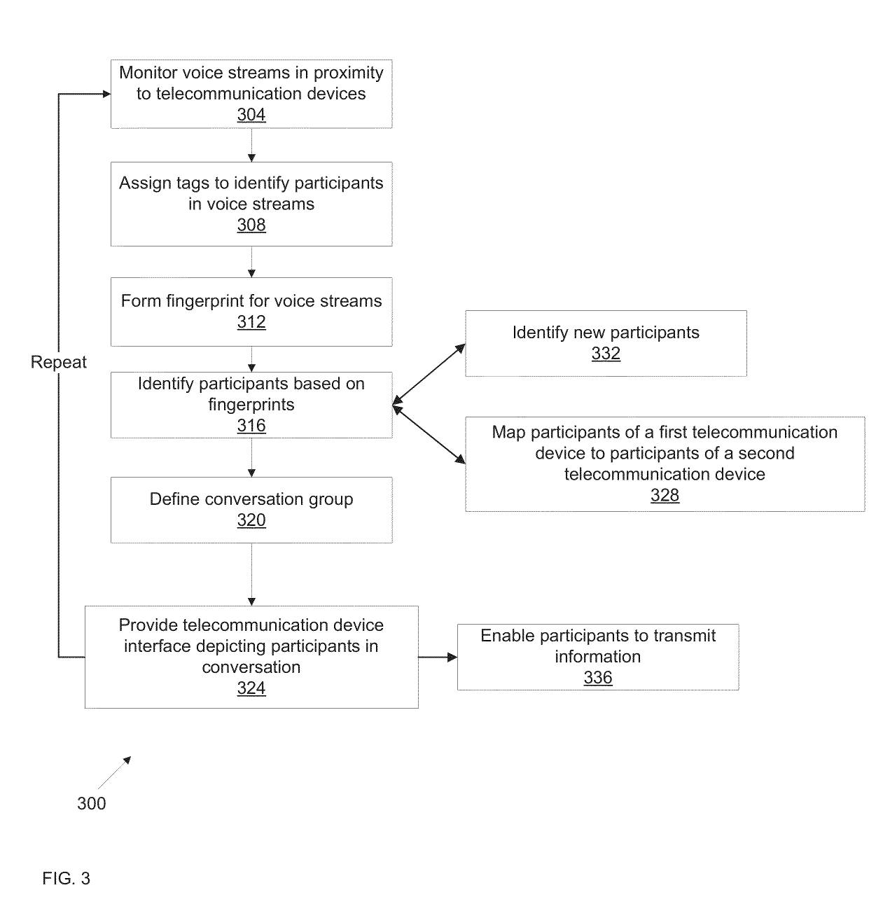

FIG. 3 is a flowchart 300 of a method for identifying a conversation between a plurality of participants, according to an illustrative embodiment (using, for example, the system 100 of FIG. 1 or the system 200 of FIG. 2). The method includes monitoring 304 voice streams in proximity to a first client device and a second client device. The first and second client devices to monitor the voice streams. In one embodiment, voice monitoring module 116 of FIG. 1 is used to monitor the voice streams. In some embodiments, there are voice monitoring modules 116 included in each client device 106, such as illustrated in FIG. 2.

The method also includes assigning 308 a tag to identify the participants speaking in the voice streams in proximity to the first and second client devices. The tags can be, but are not required to be, globally unique identifiers. In addition, the tags can, but also are not required to, specify the true identity of the participants. The tags allow the system to discriminate between the people speaking within the proximity of the client devices. By way of example, referring to conversation group 104b as illustrated in FIG. 1, participant 102a has client device 106a and participant 102b has client device 106b. In this embodiment, tag “A” is assigned to participant 102a, tag “B” is assigned to participant 102b, and tag “C” is assigned to participant 102c in the voice stream monitored by client device 106a. Participant 102c is participating in conversation 104a. Tag “X” is assigned to participant 102a and tag “Y” is assigned to participant 102b in the voice stream monitored by client device 106b. Participant 102c is not tagged in the voice stream monitored by client device 106b. In one embodiment, tagging module 120 of FIG. 1 is used to assign tags to the voices in the voice streams. In some embodiments, there are tagging modules 120 included in each client device 106.

The method also includes forming a fingerprint 312, based on the assigned tags, for the voice streams in proximity to the first and second client devices. The fingerprint can also include one or more parameters associated with the people speaking in the voice streams. Different schemes can be used to form the fingerprint in various embodiments. In one particular embodiment, the fingerprint is formed using the tags and the duration of time each participant speaks. For example, a fingerprint “A_{—}5, AB_{—}1, B_{—}8, A_{—}3” is representative of A speaking for 5 seconds, A and B then simultaneously speaking for 1 second, B speaking for 8 seconds, and A speaking for 3 seconds. In one embodiment, fingerprinting module 124 of FIG. 1 is used to form the fingerprints for the voice streams in proximity to each client device. In some embodiments, there are, instead, fingerprinting modules 124 included in each client device 106, as illustrated in FIG. 2.

A fingerprint is created for each voice stream monitored by the client device. For example, in one embodiment, client device 106a forms the fingerprint “A_{—}5, B_{—}7, C_{—}3, A_{—}8” and client device 106b forms the fingerprint “X_{—}5, Y_{—}7, X_{—}8.” The fingerprint associated with the voice stream monitored by client device 106a identifies three people (tagged as “A”, “B”, and “C”) as speaking in the voice stream. The fingerprint associated with the voice stream monitored by client device 106b identifies only two people (“X” and “Y”) as speaking in the voice stream. The fingerprints are then sent, via a network connection, to a processor (e.g., processor 108 of FIG. 1) to be analyzed.

In some embodiments, the client devices share a common clock or common synchronization signal. In those embodiments, the fingerprints can include timestamps and the fingerprints can be formed to correspond to exactly the same spans of time. In addition, if a common clock exists, the system can determine the distance between the participants and each client device using, for example, time-of-analysis flight methods.

The method also includes identifying 316 which participants are participating in the conversation based on the fingerprints for the voice streams. The method involves comparing or otherwise analyzing the fingerprints to identify which participants are involved in one or more conversations. The method can include, for example, finding a common tag mapping 328 that maps participants associated with a first client device to participants associated with a second client device. In embodiments where the tags are globally unique or linked to the true identity of the participants, the mapping step is easier because the tags allow for a direct mapping to be performed between fingerprints rather than requiring for determining which tags of one fingerprint correspond to the tags of a second fingerprint.

In one embodiment, the method includes finding a common mapping that reduces a mathematically determined distance metric capturing the relationship between two or more fingerprints. In this embodiment, by analyzing the first fingerprint “A_{—}5, B_{—}7, C_{—}3, A_{—}8” and second fingerprint “X_{—}5, Y_{—}7, X_{—}8,” the method determines tag “A” of the first fingerprint corresponds to tag “X” of the second fingerprint. In addition, tag “B” of the first fingerprint corresponds to tag “Y” of the second fingerprint. Tag “C” of the first fingerprint is not mapped to a corresponding tag of the second fingerprint. Accordingly, in this situation, the mapping of the tags of the second fingerprint is based on a subset of the first fingerprint.

In some embodiments, the voice streams are broken up into N-second chunks. Each chunk is assigned to a tag of a dominant speaker in the voice stream chunk (e.g., winner-take all approach). The fingerprints are then compared using, for example, a standard approximate string matching such as Needleman-Wunsch or Baeza-Yates-Gonnet. Once an optimal alignment between fingerprints is identified a normalized edit distance can be computed.

Different metrics can be used in alternative embodiments to identify conversations and participants. One metric is the Kullback-Leibler (K-L) divergence method that is computed in accordance with:

$${D}_{S} ( P \vert Q ) = {\sum }_{1}^{i} P ( i ) log ( \frac{P ( i )}{Q ( i )} ) \qquad EQN . 1$$

Kullback-Leibler (K-L) is a measure of the difference between two probability distributions P and Q. In this implementation, each element of the distribution represents the percent chance that at any moment in a conversation that any single speaker, combination of speakers, or no speaker is talking. There are two properties of Kullback-Leibler that are considered. The first property of Kullback-Leibler is that it is desirable to make sure that the denominator Q(i) is never equal to zero, which could otherwise result in a computational error. There are various methods that can be used to accomplish this. One method involves adding a small number to both the numerator and denominator giving us:

$${D}_{{S}^{′}} ( P \vert Q ) = {\sum }_{1}^{i} P ( i ) log ( \frac{P ( i ) + 0.0001}{Q ( i ) + 0.0001} ) \qquad EQN . 2$$

The second property of Kullback-Leibler that is considered involves the fact that it is asymmetric. This means the K-L calculation from P to Q is generally not the same as the K-L calculation from Q to P. There are various methods to produce the symmetric Kullback-Leibler, one of these is involves taking the average of the different orders in accordance with:

$${D}_{k} ( P \vert Q ) = \frac{{D}_{{S}^{′}} ( P \vert Q ) + {D}_{{S}^{′}} ( Q \vert P ) )}{2} \qquad EQN . 3$$

In this implementation, each element of the probability distributions (P and Q) represents the percent chance that at any moment in a conversation that any single speaker, combination of speakers, or no speaker is talking. Therefore, the element list must be the set of all k-combinations of a set S

$$( \begin{matrix}S \\ k\end{matrix} )$$

where S denotes the speakers in the conversation and 1<=k<=|S|. The distribution P(i) would be the tested potential conversation as derived from sampled voice streams and Q(i) would be a known conversation model as derived from a corpus of known conversations. There may be more than one conversation model within a set of sampled voice streams. For example, in one implementation, given a number of participants there might exist a social-conversation model, confrontational-conversation, model, etc. in a set of sampled voice streams.

The method illustrated in FIG. 3 also includes defining 320 a first conversation group (e.g., group 104b of FIG. 1) that includes the participants identified as participating in the conversation. In the above example, the first conversation group includes participants 102a (with commonly mapped tags “A” and “X”) and 102b (with commonly mapped tags “B” and “Y”).

Once a conversation group is identified, the method includes providing 324 an interface to the first and second client devices including graphical representations depicting the participants in the conversation. One such interface could be a display output device 214 of client device 106, as illustrated in FIG. 2.

The method also includes enabling 336 the participants to transmit information to each other. In one embodiment, the participants are able to transmit their own contact information to the other participants or transmit a document they wish to share. In another embodiment, the graphical representations are icons that enable a participant to execute code that represents instructions that allow a participant to share information (e.g., messages, photos, adding friends to social networking site account) with one or more other participants. In some embodiments, the method also includes the optional step of storing information regarding the conversation or participants (e.g., storing keywords or topics of discussion identified in the conversation by, for example, the system 100 of FIG. 1).

The method also includes repeating each of the steps to, for example, identify 332 new participants in the conversations. When new participants are identified, the method disclosed in FIG. 3 can include expanding the conversation groups by adding the new participants.

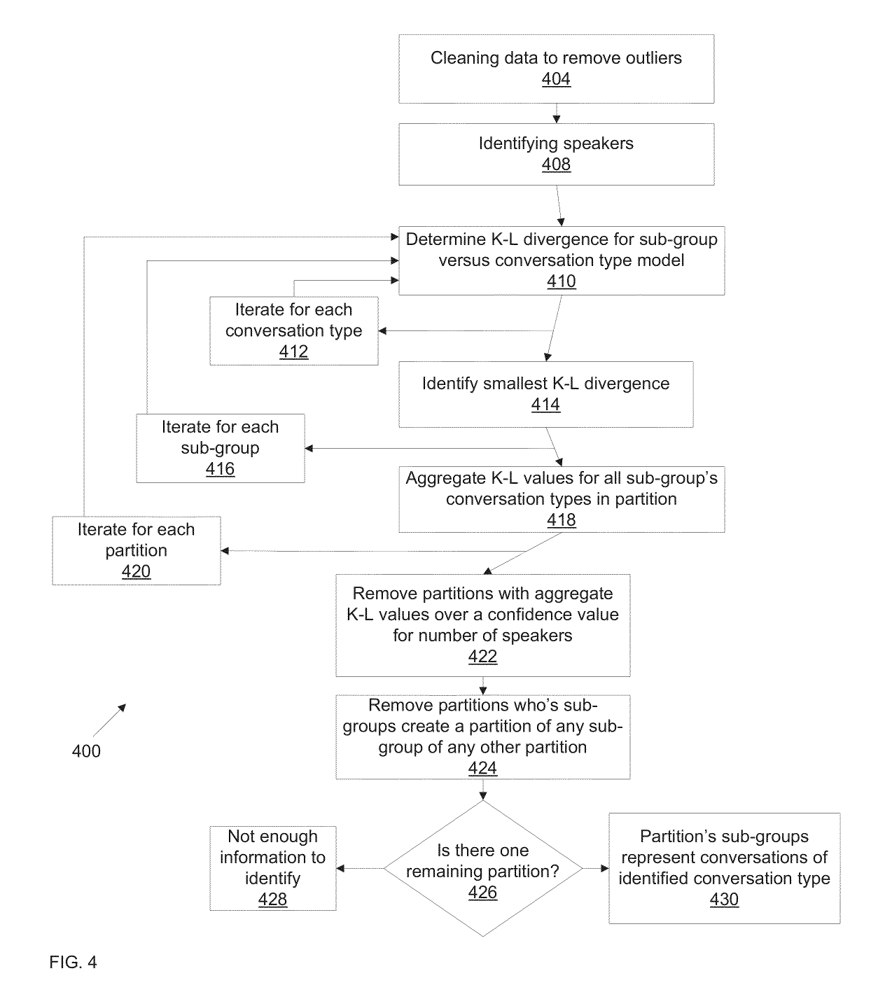

FIG. 4 is a flowchart 400 of one embodiment of a method for identifying conversations between participants in which the Kullback-Leibler divergence method is used to define a conversation group (in accordance with steps 316 and 320 of FIG. 3). The method can include the optional step of cleaning 404 the data to remove outliers (e.g., non-voice data, or other signals which might confuse or compromise the system) and to perform any other necessary data cleaning or data filling to deal with fragmented or missing data. Next, the method includes identifying 408 the speakers (e.g., as described above with respect to the fingerprinting module 124 of FIG. 1 or of FIG. 2 and/or the method of FIG. 3).

The method illustrated in FIG. 4 iterates through each conversational partition of the speakers. For each of these partitions the sub-groups represent potential conversations and the sub-group's membership is its speakers. Missing data inside of this system is a possibility and so subgroups down to 1 member are treated as a possible input. For each subgroup within the partition, a frequency distribution P is created for every combination of speaker. Each element of the distribution represents the percent chance that at any moment in a conversation that any single speaker, combination of speakers, or no speaker is talking. Therefore the element list must be the set of all k-combinations of a set S

$$( \begin{matrix}S \\ k\end{matrix} )$$

where S denotes the speakers in the conversation and 1<=k<=|S|. P is then compared to one or more conversational models Q of the same number of participants using Dₖ (P|Q). In this manner, at step 410, the flowchart 400 determines a K-L divergence for a sub-group identified in step 408. At step 412, this process is iterated such that a K-L divergence is determined for each sub-group.

At step 414, the K-L divergence values for the various models Q are compared and the lowest one selected, this represents the closest matched conversation type for the sub-group. This is repeated for every sub-group within the partition, at step 416. Subsequently, at step 418, the best matches are aggregated together to create an aggregate K-L score for the partition. At step 420, this aggregation is repeated for each partition such that every partition has an aggregate K-L score.

Using a large corpus of known conversations it is possible to derive a likely confidence interval for each number of speakers, a K-L value under which it is likely that the matched conversation, or partition represents a close enough match to be considered valid. At step 422, from our computed set of aggregate K-L value for each partition, we can remove any partition which has an aggregate K-L value within or over the confidence interval and, at step 424, for which a combination of its sub-groups form a partition of any sub-group of any other partition with an aggregate K-L value within or over the confidence interval. At step 426, the flowchart 400 asks if there are any remaining partitions, and if no partitions have aggregate K-L values under the confidence interval for this number of speakers then the analysis is determined to be inconclusive at step 428. Similarly, if more than one partition has an aggregate K-L value under the confidence interval for this number of speakers then the analysis is also inconclusive. Otherwise, if there are no remaining partitions, then at step 430 the removed partitions are considered to be represented by an identified conversation type based on the various models Q.

Furthermore, an inconclusive analysis may become conclusive as more data is collected over time. In some embodiments, membership in a group may change over time. Therefore, in some embodiments, the divergence and distance measures are re-calculated at different points in time to determine if participant membership in a group has changed or if confidence in membership has changed.

Alternative distance metrics can be used in alternative embodiments. For example, the methods can include creating a signal having at least one variable (additional variables, the method to normalize the variable values, weight the variables, and determine their value in an ideal conversation, can be selected in alternative embodiments). Potential variables can include, for example, a) i_n=% of individual n's speaking time spent independently speaking, b) s=% time of the conversation spent in silence, c) t_n=% speaking-time of the conversation spent with individual n speaking, d) p=pace of speech of individual n in words/min, e) 1_n=average length of individual n's turn in seconds and/or V=the variability of the these qualities over time.

In some embodiments, for a single variable that has a value between 0 and 1, the following distance metric can be used where P(i) represents a set of variables describing one type of ideal conversation, and Q(i) represents the corresponding set of variables describing the conversation being analyzed:

D(P|Q)={square root over (Σᵢ₌₁ⁿ(P(i)−Q(i))²)} EQN. 4

The above-described systems and methods can be implemented in digital electronic circuitry, in computer hardware, firmware, and/or software. The implementation can be as a computer program product that is tangibly embodied in an information carrier. The implementation can, for example, be in a machine-readable storage device and/or in a propagated signal, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the disclosure by operating on input data and generating output. Method steps can also be performed by, and an apparatus can be implemented as, special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data. Magnetic, magneto-optical disks, or optical disks are examples of such storage devices.

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

The above described techniques can be implemented in a distributed computing system that includes a back-end component. The back-end component can, for example, be a data server, a middleware component, and/or an application server. The components of the system can be interconnected by any form or medium of digital data communication or communication network. Examples of communication networks include a local area network (LAN), a wide area network (WAN), the Internet, wired networks, packet-based networks and/or wireless networks.

Packet-based networks can include, for example, the Internet, a carrier internet protocol (IP) network, such as a local area network (LAN), wide area network (WAN), campus area network (CAN), metropolitan area network (MAN), or home area network (HAN). Networks can also include a private IP network, an IP private branch exchange (IPBX), a wireless network, and/or other packet-based networks. Circuit-based networks can include, for example, the public switched telephone network (PSTN), a private branch exchange (PBX), a wireless network, such as RAN, bluetooth, code-division multiple access (CDMA) network, time division multiple access (TDMA) network, or the global system for mobile communications (GSM) network, and/or other circuit-based networks.

The client devices can include, for example, an IP phone, a mobile device, personal digital assistant, and/or other communication devices. Mobile devices can include a cellular phone, personal digital assistant (PDA) device, laptop computer, or electronic mail device.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the embodiments described herein. Scope is thus indicated by the appended claims, rather than by the foregoing description, and all changes that come within the meaning and range of equivalency of the claims are therefore intended to be embraced therein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for identifying a conversation between a plurality of participants, the method comprising:
monitoring voice streams in proximity to at least one client device;
assigning a tag to identify each participant speaking in the voice streams in proximity to the at least one client device;
forming a fingerprint, based on the assigned tags, for the voice streams in proximity to the at least one client device;
identifying which participants are participating in a conversation based on the fingerprints for the voice streams; and
providing an interface to the at least one client device including graphical representations depicting the participants in the conversation.

2. The method of claim 1, wherein the fingerprint includes, for each participant, the assigned tag and a parameter associated with the participant speaking in the voice stream.

3. The method of claim 2, wherein the parameter associated with the participant speaking in the voice stream is a duration of time of the participant speaking.

4. The method of claim 2, wherein the fingerprint for each voice stream includes fingerprint entries for each participant individually speaking for a duration of time, two or more participants simultaneously speaking for a duration of time, or a combination of both.

5. The method of claim 1, wherein the at least one client device comprises first and second client devices and identifying which participants are participating in a conversation based on the fingerprint for each voice stream includes mapping participants associated with the first client device to participants associated with the second client device.

6. The method of claim 5, comprising mapping participants associated with the first client device to participants associated with the second client device based on a subset of the fingerprint for each voice stream.

7. The method of claim 1, comprising defining a first conversation group that includes those participants identified as participating in the conversation.

8. The method of claim 7, comprising identifying new participants participating in the conversation group.

9. The method of claim 7, comprising enabling each participant participating in the conversation group to transmit information to the other participants in the conversation group.

10. The method of claim 1, wherein the at least one client device comprises first and second client devices and the first and second client devices share a common clock or synchronization signal to align the fingerprints between the first and second client devices to map participants associated with the first client device to participants associated with the second client device.

11. The method of claim 1, wherein the steps of monitoring, assigning, and forming are performed by both the at least one client device.

12. The method of claim 1, wherein the steps of assigning and forming are performed by a common processor.

13. The method of claim 1, wherein the interface includes graphical representations of icons that enable a participant to execute code representing instructions that allow the participant to share information with another participant in the conversation.

14. A system for identifying a conversation between a plurality of participants, the system comprising:
a voice monitoring module configured to monitor voice streams in proximity to first and second client devices;
a tagging module configured to assign a tag to identify participants speaking in the voice streams in proximity to the first and second client devices;
a fingerprinting module to form a fingerprint, based on the assigned tags, for the voice streams in proximity to the first and second client devices; and
a conversation identification module configured to identify which participants are participating in a conversation based on the fingerprints for the voice streams.

15. The system of claim 14, wherein the fingerprint includes, for each participant, the assigned tag and a parameter associated with the participant speaking in the voice stream.

16. The system of claim 15, wherein the parameter associated with the participant speaking in the voice stream is a duration of time of the participant speaking.

17. The system of claim 16, wherein the fingerprint for each voice stream includes fingerprint entries for the participant speaking for the duration of time, two or more participants simultaneously speaking for the duration of time, or a combination of both.

18. The system of claim 14, wherein the conversation identification module is configured to map participants associated with the first client device to participants associated with the second client device.

19. The system of claim 18, wherein the conversation identification module is configured to map participants associated with the second client device based on a subset of the fingerprint for each voice stream.

20. The system of claim 14, wherein the system is configured to enable the participants that are participating in the conversation to transmit information to each other via the first and second client devices.

21. The system of claim 14, wherein the system has a common clock or synchronization signal to align the fingerprints between the first and second client devices to map participants associated with the first client device to participants associated with the second client device.

22. The system of claim 14, wherein the first and second client device each include a voice monitoring module, a tagging module and a fingerprinting module.

23. A computer program product, tangibly embodied in an information carrier, the computer program product including instructions being operable to cause a data processing apparatus to:
monitor voice streams in proximity to participants each having a client device;
assign a tag to identify each participant speaking in each voice stream in proximity to each client device;
form a fingerprint, based on the assigned tags, for each voice stream in proximity to each client device; and
identify which participants are participating in a conversation based on the fingerprints for each voice stream.

24. A system for identifying a conversation between a plurality of participants, the system comprising:
a processor; and
a memory, the memory including code representing instructions that when executed cause the processor to:
monitor voice streams in proximity to first and second client devices;
assign a tag to identify the participants speaking in the voice streams in proximity to the first and second client devices;
form a fingerprint, based on the assigned tags, for the voice streams in proximity to the first and second client devices; and
identify which participants are participating in a conversation based on the fingerprints for the voice streams.
